(19) United States
(12) Patent Application Publication
(10) Pub. No.: US 2016/0108652 A1
(43) Pub. Date: Apr. 21, 2016

(54) Outward Swinging Door Anti-Breach Device (Lockemout 1)

(71) Applicant: Adam Talbot Ratley, Anabel, MO (US)

(72) Inventor: Adam Talbot Ratley, Anabel, MO (US)

(21) Appl. No.: 14/519,673

(22) Filed: Oct. 21, 2014

(51) Int. Cl. E05C 17/54

(52) U.S. Cl. CPC E05C 17/54

(57) ABSTRACT

This product provides an extremely uncomplicated, high quality, physics-based lockdown device at an affordable price, even for facilities on a limited budget. This device is one of three different products that were primarily conceived for use in schools, and other public facilities, where multiple types of doorways are used and overall cost is a major factor. Unfortunately, the state of certain societal conditions now dictates that such extreme security measures are not only necessary, but that it will most likely soon be mandatory for these facilities to obtain some form of security device to lock down the facility in the event of an armed intruder. This is such a device.

A device to secure outward swinging doors comprising:
(a) An injection molded or fabricated bracing frame,
(b) A metal camlock,
(c) An easy pull handle, and
(d) A nylon strap

Whereby said camlock is connected to the bracing frame and said nylon strap with attached easy pull handle is threaded through the camlock, allowing a user to mount assembled device to the handle of an outward swinging door and by pulling on the easy pull handle, cinches the nylon strap tight through the camlock, effectively securing the door from unwanted intrusion.

### BACKGROUND

With the heightened danger and frequency of intruders bent on ill intent, there is an urgent and immediate need to quickly and easily lock down any given door of a facility in a dangerous, or life threatening situation. In a real scenario, panic can rapidly overwhelm even frequently practiced responses if too much thought of what needs to be done is required. It is therefore essential that in an emergency, the order for lockdown procedures be accomplished immediately, with as few steps as possible and the minimum amount of thought required, to eliminate potential delays or mistakes caused by panic, and thereby save lives. Other products have addressed this issue, but most are prohibitively expensive for a facility on a budget, and/or require minor to moderate modifications to the facility, that can easily be subject to catastrophic failure at the critical time if not diligently maintained, or address confuting an intruder, rather than locking them out.

### BRIEF SUMMARY OF THE INVENTION

This lockdown device when properly applied will delay or deny entry to a room with an outward opening door. This device utilizes a bracing frame, a cam buckle and nylon strap, and an easy-pull handle to effectively lock down a room in seconds.

### BRIEF DESCRIPTION OF THE DRAWINGS

FIG. 1 (Attch. 1) Outward opening door lockdown device (plastic).

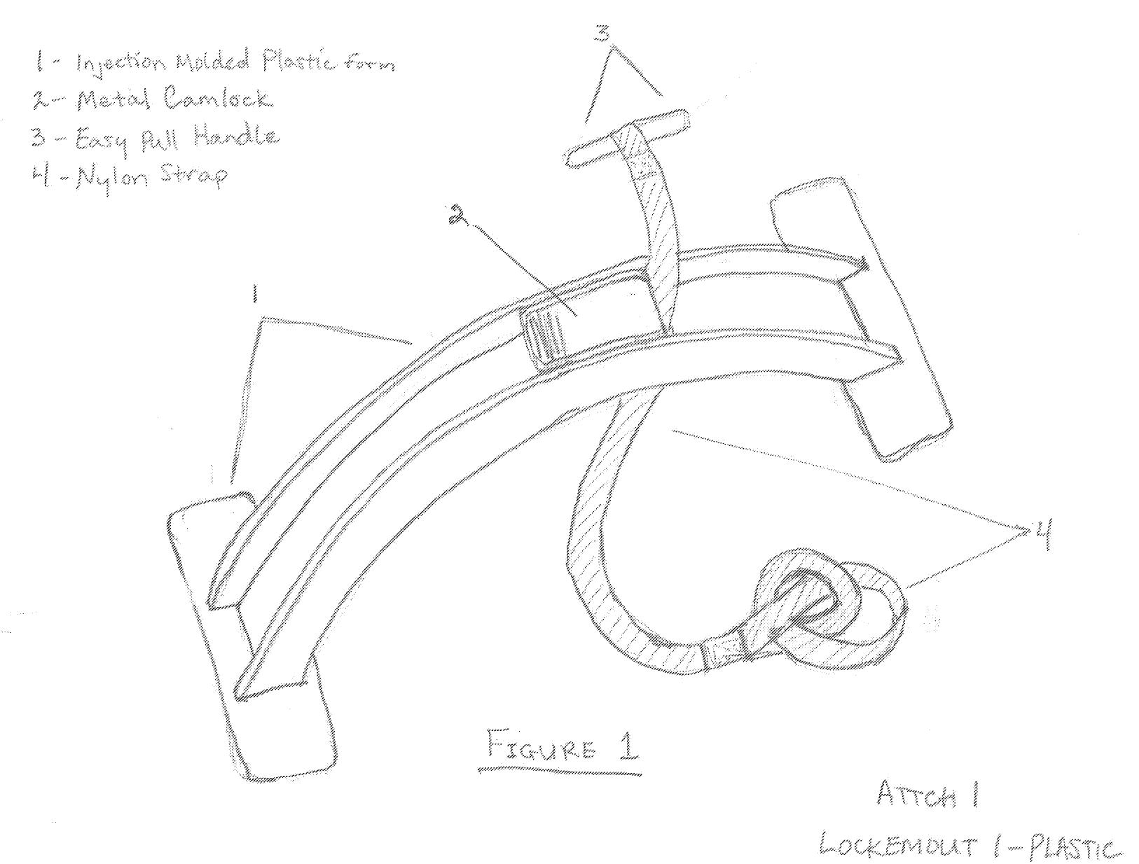

FIG. 2 (Attch. 2) Outward opening door lockdown device (metal).

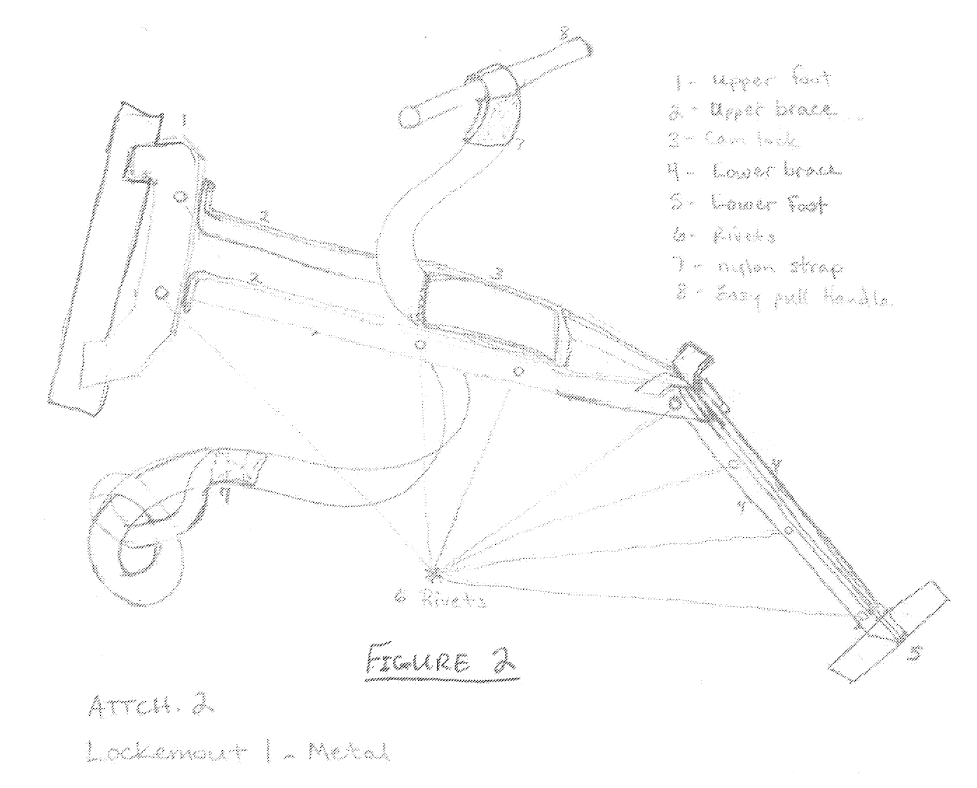

### DETAILED DESCRIPTION AND BEST MODE OF IMPLEMENTATION

Outward opening door lockdown device with some embodiments utilizing a uniquely designed one piece injection molded plastic bracing form, and other embodiments using uniquely designed metal parts that when combined would make up the bracing form. The plastic embodiment would have an appropriate sized slot incorporated into the main part of the brace for a cam lock to be press-fit into it. The metal embodiment of the bracing form would be made from one upper foot piece with two rivet holes that would be attached to the upper brace piece. Some embodiments may be welded for additional strength. The upper foot prevents the device from tilting sideways when engaged. Plastic or rubber pieces can be press fit onto the upper foot to prevent it from slipping against the door and marring the paint or the door itself. The upper brace piece of the metal embodiment is made from two strips with a short 90 degree bend at one end of each strip. Holes are placed to allow it to be riveted to the upper foot. Some embodiments may be welded for additional strength. A cam lock is riveted into place between the two strips, and the ends of the strips opposite the 90 degree bends, and past the attached cam lock, are bent together and holes drilled to allow the upper brace to be bolted to the lower brace. Some embodiments may have the cam lock welded into place instead of riveted. The lower brace piece is made of two strips with angled 90 degree bends at one end to allow the lower foot to be locked in place when folded out and force is applied to the device using the nylon strap and cam lock. Holes are place along the lower foot to rivet the two lower foot strips together for strength and to allow the lower brace piece to be bolted to the upper brace piece, thereby allowing it to pivot. A lower foot is riveted or welded to the lower brace piece, preventing the device from tilting sideways when engaged. A plastic or rubber foot cover can be press-fit onto the lower foot assembly to prevent slipping against the door and marring of the paint or the door itself. Magnets can be attached to the upper and lower feet if desired to prevent the device from sliding on metal doors and frames when engaged. A nylon strap is used with the cam lock, which utilizes a securely sewn doorknob cinch loop on one end, and a securely sewn loop on the other end, through which an easy-pull handle is attached. The plastic embodiment of this device can include an optional magnetic strip secured onto the upper and lower feet of the device to prevent the device from sliding on metal doors and frames when engaged. Using higher grades of plastics, metals, cam locks and nylon strapping would enhance the strength and durability of these components and the overall device respectively. The device is properly employed by fully pivoting the lower brace as far as it will go, then slipping the doorknob cinch loop over the doorknob or handle of the door and cinching it down as tight as possible. The fully opened bracing form is then placed against the door and the easy-pull handle is pulled until the nylon strap has slid through the cam lock as far as possible. The handle is then released and the door is secure. To remove the device, press the cam lock release lever and pull on the device to allow the nylon strap to slide through the cam lock, then loosen and remove the cinch loop from the doorknob or handle.

1. High quality, reliable and affordable stand-alone door lockdown device, requiring no facility modification, while also being extremely simple to use, even under stress.
